(19) United States
(12) Patent Application Publication
(10) Pub. No.: US 2024/0223322 A1
(43) Pub. Date: Jul. 4, 2024

(54) COMPRESSED MESSAGING IN BANDWIDTH-SENSITIVE SETTINGS

(71) Applicant: T-MOBILE INNOVATIONS LLC, Overland Park, KS (US)

(72) Inventor: Raymond Emilio REEVES, Orlando, FL (US)

(21) Appl. No.: 18/147,946

(22) Filed: Dec. 29, 2022

(51) Int. Cl. H04L 5/00; H04W 4/12

(52) U.S. Cl. CPC H04L 5/0035; H04W 4/12; H04W 84/06

(57) ABSTRACT

Systems and methods are provided to improve transmittance of messages across bandwidth limited networks. Modern telecommunication networks utilize radio frequency (RF) signaling to transmit and receive signals between a base station and a user equipment. Particularly for some base stations, bandwidth availability may be limited based on its location with respect to the mobile originating devices or that the base-station may be non-terrestrial. Such limited bandwidth restricts the amount of messaging that may be transmitted. By utilizing a series of coding and decoding of messages, these messages may use less bandwidth and reduce strain on those limited base stations.

### SUMMARY

The present disclosure is directed, at least in part, to compressing messaging over a bandwidth restricted network to improve the transmission of messages while using bandwidth restricted networks, substantially as shown in and/or described in connection with at least one of the figures, and as set forth more completely in the claims.

In aspects set forth herein, a system is used to improve transmittance of messages across bandwidth limited networks. Modern telecommunication networks utilize radio frequency (RF) signaling to transmit and receive signals between a base station and a user equipment. Particularly for some base stations, bandwidth availability may be limited based on its location with respect to the mobile originating devices or that the base-station may be non-terrestrial. Such limited bandwidth restricts the amount of messaging that may be transmitted. By utilizing a series of coding and decoding of messages, these messages may use less bandwidth and reduce strain on those limited base stations.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an exemplary computing environment suitable for use in implementations of the present disclosure;

FIG. 2 depicts an exemplary system in which implementations of the present disclosure may be employed;

FIG. 3 depicts an exemplary network in which implementations of the present disclosure may be employed;

FIG. 4 depicts an exemplary network in which implementations of the present disclosure may be employed; and

FIG. 5 depicts a flow diagram of an exemplary method in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. A base station suitable for use with the present disclosure may be terrestrial (e.g., a fixed/non-mobile form such as a cell tower or a utility-mounted small cell) or may be extra-terrestrial (e.g., an airborne or satellite form such as an airship or a satellite).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional wireless telecommunications network employs a plurality of base stations to wirelessly transmit signals to a user device and wirelessly receive signals from the user device. In a wireless communication system, there are many reasons why it may be desirable to compress or otherwise reduce the size of mobile originating (MO) messages. For example, a terrestrial base station may become unusually congested when it serves a sporting event venue or in the vicinity of an emergency situation. In another example, some base stations, such as extraterrestrial base stations may serve very large areas and many more UEs than a typical base station. In such situations, it would be beneficial for a network operator to reduce the size of mobile originating (MO) messaging in order to maximize the number of UEs that could be effectively served.

Especially because conventional solutions to managing MO messaging in bandwidth sensitive environments took place in terrestrial environments, they may have little or no applicability when the base station is deployed in space. That is because the conventional understanding of bandwidth sensitivity is viewed through the lens of base station radio resource management or network planning. Accordingly, conventional solutions related to handing UEs that are disposed further from a congested base stations to a different base station, modifying priority/scheduling schemes, or even deploying additional base stations to areas that are prone to congestion.

Unlike conventional solutions, the present disclosure is directed to compressing MO messaging, in particular text messaging, without having to modify base station scheduling and without the need for an overlapping neighbor cell. Accordingly, a paradigm is presented herein that utilizes a dictionary or translator at the MO UE that translates a text message input by a user into a much shorter string, and communicates the translated message to the telecommunication network via the bandwidth restricted base station. Once the translated message reaches a resource-rich location such as a centralized computing center, the translated message can be converted into a form that can be communicated to an MT UE and communicated thereto.

Accordingly, a first aspect of the present disclosure is directed to a method for managing bandwidth-sensitive messaging. The method comprises receiving a first message from an originating user equipment (UE) via a bandwidth-restricted base station. The method further comprises determining that the first message is encoded according to a first codebook. The method further comprises determining that the first message is destined for a terminating UE. The method further comprises determining the terminating UE is configured to decode incoming messages according to a second codebook. The method further comprises communicating a second message to the terminating UE according to the second codebook.

Another aspect of the present disclosure is directed to a system for managing bandwidth-sensitive messaging. The system comprises a non-transitory computer storage media and one or more computer processing components. The one or more computer processing components are configured to determine that a first message has been received by a first base station and that the first base station is bandwidth-restricted. The one or more computer processing components are further configured to determine that the first message is encoded according to a first codebook used by an originating user equipment (UE) to encode an alphanumeric input. The one or more computer processing components are further configured to determine the first message is destined for a terminating UE and that the terminating UE utilizes a second codebook to decode received messages. The one or more computer processing components are further configured to communicate a second message to the terminating UE, wherein the second message is decoded according to the second codebook to create an alphanumeric output equal to the alphanumeric input by the originating UE.

Yet another aspect of the present disclosure is directed to a non-transitory computer readable media having instructions stored thereon, that when executed by one or more computer processing components, cause the one or more computer processing components to perform a method for managing bandwidth-sensitive messaging. The method further comprises determining that the first message is encoded according to a first codebook. The method further comprises determining that the first message is destined for a terminating UE. The method further comprises determining the terminating UE is configured to decode incoming messages according to a second codebook. The method further comprises communicating a second message to the terminating UE according to the second codebook.

Another aspect of the present disclosure is directed to a system for bandwidth-restricted messaging. The system comprises a transmitter for wirelessly communicating with a base station. The system further comprises a non-transitory computer readable media. The system further comprises an alphanumeric input component. The system further comprises one or more computer processing components configured to receive an alphanumeric input via the alphanumeric input component. The one or more computer processing components are further configured to determine that the system is attached to the base station and that the base station is bandwidth-restricted. The one or more computer processing components are further configured to, based on said determination, create an encoded message by encoding the alphanumeric input according to a codebook stored on the non-transitory computer readable media. The one or more computer processing components are further configured to cause the system to communicate the encoded message to the base station.

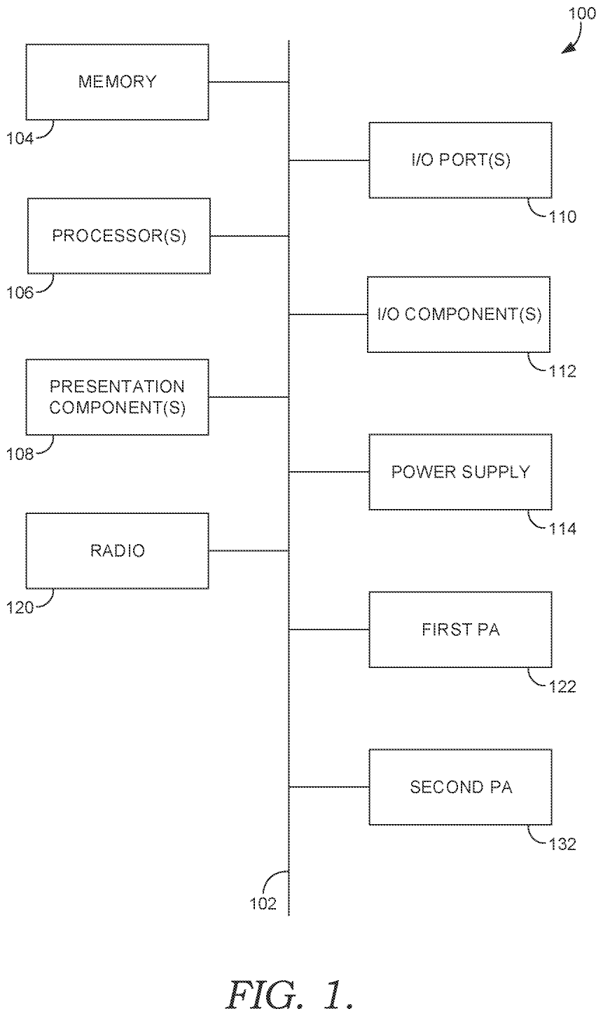

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take many forms; non-limiting examples of the computing device 100 include a fixed wireless access device, cell phone, tablet, internet of things (IOT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, non-removable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VOLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

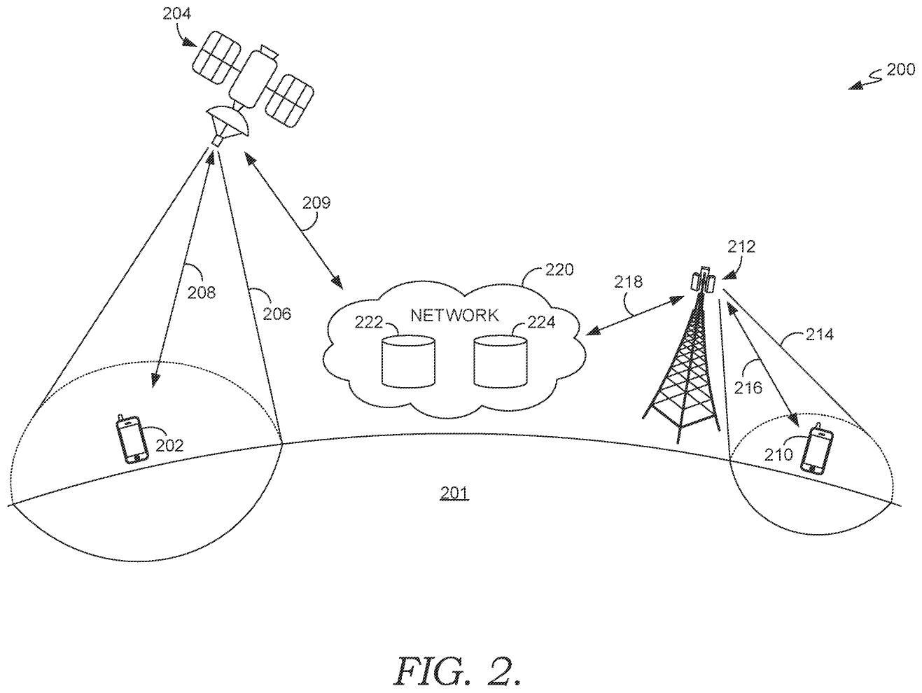

Turning now to FIG. 2, a representative network environment in which the present disclosure may be carried out is illustrated. Such a network environment is illustrated and designated generally as network environment 200. Network environment 200 is but one example of a suitable network environment and is not intended to suggest, including by the form of any illustrated component thereof, any limitation as to the scope of use or functionality of the invention. Neither should the network environment be interpreted as having any dependency or requirement relating to any one or combination of components illustrated.

The network environment 200 generally represents a high-level model for wirelessly communicating between a base station and a fixed wireless access device, as discussed in greater detail herein. The network environment 200 comprises a ground surface 201, a mobile originating (MO) device 202, a MO base station 204, a coverage area 206, a communication link 208, a mobile terminating (MT) device 210, a MT base station 212, coverage area 214, communication link 216, communication link 218, a network 220, and databases 222 and 224. The network environment 200 may also be said to comprise a network 220, and one or more computer processing components.

The network environment comprises at least one MO base station 204 and MT base station 212 that is configured to wirelessly communicating with one or more user devices, such as the computing device 100 of FIG. 1, which may take the form of the MO user device 202 and MT user device 210. For the purposes of this disclosure, a base station is used in its general sense, being defined as a station for transmitting and/or receiving RF signals; accordingly, the at least one MO base station 204 and MT base station 212 may take the form of a cellular node (e.g. eNodeB, gNodeB, etc.), a relay, or any other desirable emitter and/or receiver of signals that remains fixed in place while a set of wireless signals are transmitted/received. A suitable base station is not protocol-specific, it may be configured to be any wireless telecommunication protocol that is compatible with the MO user device 202 and MT user device 210, such as 4G, 5G, 6G, or any other wireless standard. A suitable base station is also not exclusive to cellular telecommunication networks, it may take the form of any wireless communication system and used at any desirable frequency (e.g., microwave relays). Base stations consistent with the present disclosure may be configured to serve a certain geographic area (i.e., a cell) and will have one or more backhaul connections that connect it to a broader telecommunications network, such as the network 220, for the provision of telecommunication service to the fixed user devices 202 and 210. As illustrated, the the MO base station 204 and MT base station 212 may take the form of a macro cell; however, the at least one MO base station 204 and MT base station 212 may take any desirable form, such as a small cell. As seen in the embodiment illustrated by FIG. 2, base stations suitable for use in the present disclosure may be terrestrial, that is, they are coupled to the earth via a tower or some other structure, such as the MT base station 212; alternatively, a suitable base station may be extra-terrestrial, that is coupled to an aircraft or a satellite, such as the MO base station 204.

In order to communicate with the MO user device 202 and the MT user device 210, the the MO base station 204 and MT base station 212 may be said to communicate along a communication links 208, 209, 216 and 218 of the air interface, wherein one or more sets of downlink signals are sent to the user devices 202 and 210 from the at least one MO base station 204 and MT base station 212, and one or more sets of uplink signals are communicated from the user devices 202 and 210 to the at least one MO base station 204 and MT base station 212. Though illustrated as a straight line representing a single, direct, line of sight connection, one skilled in the art will appreciate that the reality of RF communications means that the communication links 208, 209, 216 and 218 may not be singular (i.e., there may be multiple paths), may not be direct (i.e., there may be reflections and/or refractions that cause the communication links 208, 209, 216 and 218 to have multiple or indirect paths), and it may not be line of sight (i.e., the communication links 208, 209, 216 and 218 may be reflected off structures, the ground, or the ionosphere, whether or not a direct line of sight connection exists).

Though each user device in FIG. 2 is illustrated as using a single base station, the network environment 200 may comprise multiple base stations, including multiple base stations that serve the same user devices 202 and 210, such as through the use of dual connectivity technology; further, additional base stations may provide overlapping or auxiliary coverage in the event an outage occurs at the MO base station 204 and MT base station 212. Each base station of the network environment 200, including the MO base station 204 and MT base station 212, comprises one or more antennas that propagate to or receive signals from the air interface or through space. Though illustrated in FIG. 2 as an antenna array, the one or more antennas of the MO base station 204 and MT base station 212 may take any desirable form, configured for the particular types of signaling between the MO base station 204 and MT base station 212 and the user devices 202 and 210, including omni-directional, dipoles, single antenna systems, antenna arrays such as multiple-input, multiple-output (MIMO) and single-input, single-output (SISO) arrays, massive MIMO, and many others. For the purposes of present disclosure, it is sufficient to illustrate that one or more sets of downlink signals originate from, and one or more uplink signals are received at, the one or more antennas and the communication links 208, 209, 216 and 218 bridges the one or more antennas and the user devices 202 and 210. In aspects, MO user device 202 is within the coverage area 206 of the MO base station 204. In one aspect, the MO base station 204 may be bandwidth limited which would trigger the MO user device 202 to provide communications using an encoded message rather than full message. The MO base station 204 may provide the MO user device 204 an indication that the base station is operating on a bandwidth limitation.

The network environment further comprises at least one MO user device 202 and MT user device 210. The MO user device 202 and MT user device 210 may be said to include any one or more components of the computing device 100 of FIG. 1. Generally, the MO user device 202 and MT user device 210 provides wireless connectivity between the MO user device 202 and MT user device 210 and the MO base station 204 and MT base station 212 and then provides a connection to other devices in proximity to the wireless access device 204. Accordingly, and despite the fact that the MO user device 202 and MT user device 210 is illustrated in FIG. 2 and described with specificity herein as a home internet gateway, any fixed station suitable for wirelessly communicating with the MO base station 204 and MT base station 212 is suitable for use with the present invention; for example, the MO user device 202 and MT user device 210 could take the form of a second base station (e.g. a macro or small cell), a consumer premise equipment (CPE), access point, relay, and the like. A typical deployment scenario for the MO user device 202 and MT user device 210 is within a structure, within which signals from the MO base station 204 and MT base station 212 may be attenuated to the point that they degrade the ability of UEs within the structure 214 to access one or more services of the network 208, to which the MO base station 204 and MT base station 212 is connected. Accordingly, a user device consistent with the present disclosure may comprise a processor 106, power supply 114, radio 116, and bus 102. Because the fixed wireless access device is not typically configured for extensive interactions with users, such a device may not comprise a presentation component 108 or the I/O port(s) 110. In other aspects, the presentation component 108 may comprise a display of reduced size. The MO user device 202 and MT user device 210 may comprise an I/O port, whether wired or wireless, that provides a connection interface between the fixed wireless access device and other routing device or UEs. For example, the MO user device 202 and MT user device 210 may be configured to transmit a set of communication links 208, 209, 216 and 218 to one or more wireless communication devices (not illustrated); the communication links 208, 209, 216 and 218 may be configured according to any desirable wireless communication standard, such as 802.11 series or conventionally-cellular standards such as 3G/4G/5G/6G, and the like. Additionally or alternatively, the MO user device 202 and MT user device 210 may be configured with a wired communication port, such as an Ethernet port, that provides a wired connection to a user device (e.g., a personal computer) or to a router (e.g., a whole-home router, mesh network router, etc.).

The network environment 200 further comprises a network 220 which has at least a first database 222 and a second database 224. Each database is configured to house one or more data set associated with a user device such as the MO user device 202 and MT user device 210. In one embodiment, the first database is configured to have a set of data which acts like a dictionary for the MO user device 202. Such data sets may be configured to store common text or spoken phrases by the user of the MO user device 202. The common phrases identified and stored in the first database 222 are associated and assigned a shortened encoded message. For example, the common message stored in the database 222 for MO user device 202 “I love you, Jennifer” may be assigned a shortened encoded message of “1KP”. The network 220 may also use processors to identify common phrases used by a user of the MO user device 202. The stored data set may be a common data set for all users within a particular geographical area. The stored data set may also be common for all users of a network. The databases may be stored on a network server or also locally on the MO user device 202 and the MT user device 210. In one aspect, the first database 222 and the second database 224 are identical. In another aspect, the first database 222 and the second database 224 are not identical. In a further aspect, the first database 222 is specific to the MO user device 202 and the second database 224 is specific to the MT user device 210. The dataset for the MO user device 202 may also have stored therein an indicator that provides the network an notification that a text or message has been encoded. For example, a message may be encoded using a phrase within first database 222 and an alphanumeric indicator may be inserted at the beginning of the encoded message.

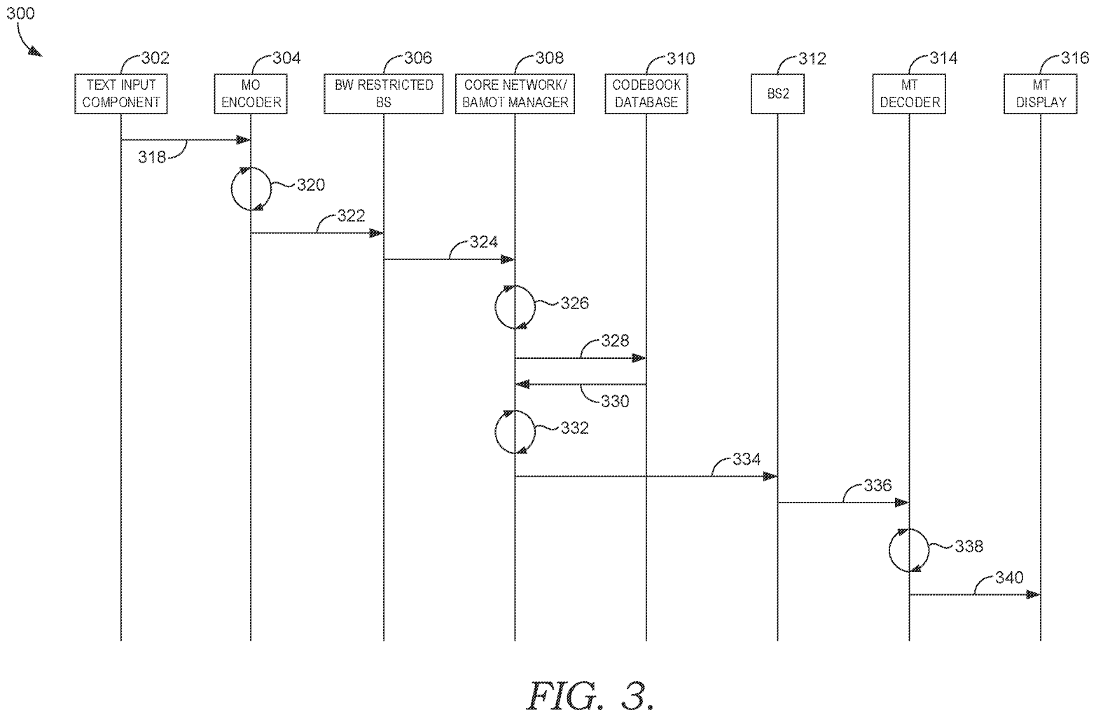

Turning now to FIG. 3, a swim lane diagram is provided, illustrating a process flow for a system managing bandwidth-sensitive messaging. Each aspect and component described herein may be performed or associated with one or more component or aspect described above with respect to FIG. 1 or FIG. 2. Swim lane diagram 300 is but one example of a suitable system and is not intended to suggest, including by the form of any illustrated component thereof, any limitation as to the scope of use or functionality of the invention. Neither should the system be interpreted as having any dependency or requirement relating to any one or combination of components illustrated.

Beginning with the text input component 302. In one aspect, the text input component may originate with the user of the MO user device 202 inputting a message. For the purposes of the present disclosure, such MO messaging or text input may take the form of SMS or other text-form messaging or a voice call. The MO user device may receive an indication that the MO user device is attached to a bandwidth limited base station. This may be indicated based on active traffic, bandwidth restrictions, number of active connections, the base station being non-terrestrial, or other bandwidth related indicators. Since the MO user device is attached to a bandwidth limited base station, the text input is then sent at step 318 to the MO encoder 304. The MO encoder, at step 320 processes the input text to determine if the message is one of a set of stored phrases or messages within the MO codebook. The MO codebook corresponds to the dataset described with respect to the first database 222 in FIG. 2. The MO encoder will determine if the text is found within the codebook and then encode the message using the corresponding encoding message. The codebook associated with the MO user device may have hundreds of phrases or words stored therein and corresponding shorthand code. The MO encoder may also input a encoding indicator within the message. The encoder indicator may be within the header of the message such as a 1 or a 0 indicating the message is encrypted. Additionally, the codebook may have a unique codebook identifier in the message itself, which would spare the network from looking it up.

The encoded message or text is sent, at step 322, to the bandwidth limited base station 306. The bandwidth limited base station 306 may be a terrestrial or non-terrestrial base station. The base station is determined to be bandwidth limited based on congestion, actual traffic, location, signal quality, availability, or other indicators. The bandwidth limited base station 306 will send the encoded message to the core network 308 at step 324. The core network 308 may then determine if the message is encoded or not. This may be based on an indication placed in the header of the message. The message itself may also have an indication that the message is encoded. For example, any message that has a particular series of characters may be an encoded message. The core network 308 may also user the location of the bandwidth limited base station to actively detect for encoded messages.

Once the core network 308 determines that the message is encoded, it queries the codebook database 310 at step 326. The query searches the codebook database 310 to determine what the original message was. The codebook database may have a codebook that is specific to the MO user device and a separate codebook that is associated with the MT user device. It is determine if the first codebook is different than the second codebook is based on comparing a query of the codebook database comprising copies of the first codebook and the second codebook. Additionally the codebook database is queried first to see if a MO codebook identifier and a MT codebook identifier are the same, and only if they are different would the processor inspect the codebooks to determine that the alphanumeric input is not the same according to the MO and MT codebook, at which point it is decoded according to the MO codebook and either re-encoded according to the second codebook or communicated to the MT UE in the clear. The encoded message may have a codebook indicator to indicate which codebook of a plurality of codebooks within the codebook database is being used by the MO user device. In some instances, the MO codebook is downloaded to the MO user device upon entry into a coverage area for a bandwidth limited base station. In other aspects, the MO codebook is pre-set or downloaded by the user or upon set-up of the MO user device.

If the MO codebook and the MT codebook are the same, the codebook database will return an indication that the encoded message need not be decoded by the core network 308. In the case that the MO codebook and the MT codebook are not the same, the codebook database will return an indication that they are not similar and will also return an indication of how to encode the message for the MT user device. For example, the original message may not have the same encoding for the MO codebook and the MT codebook. Thus, the codebook database will identify the original message based on the encoded message. It will then find the encoded message within the MT codebook and return, to the core network 308 at step 330 the new encoding for the MT user device. Additionally, it may be determined that the first message is not equal to the alphanumeric input when decoded according to the second codebook; and generating the second message without bandwidth-conserving encoding by decoding the first message according to the first codebook prior to communicating the second message to the terminating UE. This signifies that that the message doesn't mean the same thing with both code books and so it communicates the message to the MT user device without bandwidth-conserving encoding.

The core network 308 at step 332 will encode the message based on if the codebook for the MT user device is the same or different than the codebook for the MO user device. If the codebooks are the same, the encoded message will remain the same. If the codebooks are not the same, the core network 308 will encode the original message based on the encoding for the MT user device found within the codebook database 310. The coded message will be sent to the MT base station 312 at step 334 and on to the MT decoder at step 336. The MT decoder 314 will decode the encoded message into the original message. The MT decoder will have access to the MT codebook that may be the same as the MO codebook or it may be different. Since the Core network 308 has encoded the message based on the MT codebook, the MT decoder will use the MT codebook to decode the encoded message for display on the MT display 316.

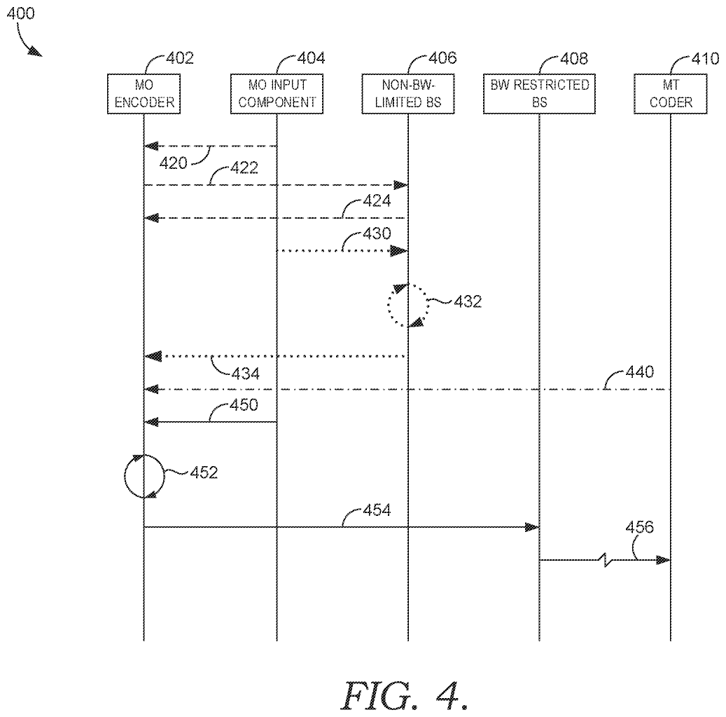

Turning now to FIG. 4, a swim lane diagram is provided, illustrating a process flow for a system managing bandwidth-sensitive messaging. Each aspect and component described herein may be performed or associated with one or more component or aspect described above with respect to FIG. 1 or FIG. 2. Swim lane diagram 400 is but one example of a suitable system and is not intended to suggest, including by the form of any illustrated component thereof, any limitation as to the scope of use or functionality of the invention. Neither should the system be interpreted as having any dependency or requirement relating to any one or combination of components illustrated.

Similar to the description of FIG. 4, the MO user device receives input by a user of the MO input 404. This may be done at a MO user device such as user devices described above. That input is sent, at step 420, to the MO encoder 402. The MO encoder may indicate that it requires the codebook which it will in-turn query the network by way of sending a query to the non-bandwidth limited base station 406. This query may be to a database such as codebook database 310 described above. The user input may be the query for the core network found associated with the non-bandwidth limited base station 406. The codebook for the MO device is either downloaded or the encoding message is sent to the MO encoder 402 by way of step 424.

In another aspect, the user input 404 is sent directly to the non-bandwidth limiting base station 406. The core network associated with the non-bandwidth limiting base station 406 may have the database of codebooks wherein the codebook for the MO user device may be downloaded. Or in another aspect, a codebook with the user input found therein may be identified and downloaded. The MO user device may have a first codebook downloaded but the phrase being used may not be found therein. Thus a new codebook may be downloaded. Additionally, if the MO user device is entering an edge of the coverage area for the non-bandwidth limiting base station 406, a codebook may be automatically downloaded and sent to the MO encoder. The non-bandwidth limiting base station 406, may determine if the MO user device is leaving non-bandwidth limiting base station 406 coverage area at step 432 and may download a codebook to the MO user device automatically. In another aspect, the MT encoder 410 may send directly a codebook to the MO encoder 402 at step 440. This may be done when the MO user device and the MT user device communicate regularly and they share common phrases between the devices. As such, a unique MO to MT codebook may be created for just the two devices and shared.

Continuing with step 450, the MO user device may provide MO input 404 which is sent to the MO encoder 402. The MO encoder 402 may have a MO codebook downloaded which it may directly access. The MO encoder 402 will, at step 452 access the MO codebook found on downloaded on the MO user device and query the user input. It will use the codebook to encode the message at step 452. The encoded message is sent, at step 454, to the bandwidth limited base station 408. The core network will then decode, as described above with respect to FIG. 3, the encoded message and deliver the message to the MT encoder 410. The MT encoder will access the MT codebook and encode the message for delivery to the MT user device.

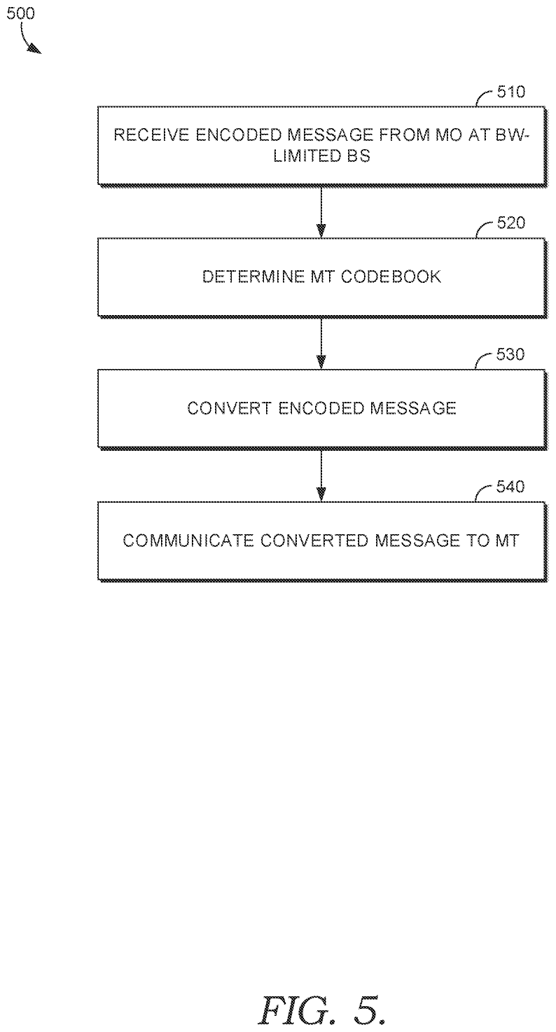

Turning now to FIG. 5, a flow chart is provided for a method 500 for managing bandwidth-sensitive messaging. At a first step 510, an encoded message is received from a MO user device. The encoded message is received at a bandwidth limited base station. In one aspect, the bandwidth limited base station is a non-terrestrial base station. According to any one or more aspects described with respect to FIGS. 2-4, the MO user device may encode a message based on a stored data set. At a second step 520, the network and/or a bandwidth messaging manager may determine what codebook or dataset is being used by the MT user device. The dataset used to encode the message and the codebook used by the MT user device may be the same. In an additional aspect, the two datasets are not the same. At step 530, the encoded message is converted based on the MT dataset or codebook. At step 540, the converted message is communicated to the MT user device.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. A method for managing bandwidth-sensitive messaging, the method comprising:
receiving a first message from an originating user equipment (UE) via a bandwidth-restricted base station;
determining that the first message is encoded according to a first codebook;
determining that the first message is destined for a terminating UE;
determining the terminating UE is configured to decode incoming messages according to a second codebook; and
communicating a second message to the terminating UE according to the second codebook.

2. The method of claim 1, wherein the bandwidth-restricted base station is a terrestrial base station having a congestion level greater than a predetermined threshold.

3. The method of claim 1, wherein the bandwidth-restricted base station is an extraterrestrial base station.

4. The method of claim 3, wherein the first codebook is stored on the originating UE and is used by the originating UE to encode an alphanumeric input into the first message.

5. The method of claim 4, wherein determining that the first message is encoded according to the first codebook is based on the first message comprising an encoded message indicator.

6. The method of claim 5, further comprising determining that the first codebook is different than the second codebook.

7. The method of claim 6, wherein determining that the first codebook is different than the second codebook is based on comparing a query of a data repository comprising copies of the first codebook and the second codebook.

8. The method of claim 7, wherein the second codebook is stored on the terminating UE and is used by the terminating UE to decode the second message to an alphanumeric output, the alphanumeric output being equal to the alphanumeric input.

9. The method of claim 8, wherein the method further comprises:
determining that the first message is not equal to the alphanumeric input when decoded according to the second codebook; and
generating the second message without bandwidth-conserving encoding by decoding the first message according to the first codebook prior to communicating the second message to the terminating UE.

10. The method of claim 4, further comprising determining that the first codebook is equal to the second codebook, wherein the second message is equal to the first message.

11. The method of claim 3, wherein the second codebook is empty and wherein the method further comprises decoding the first message according to the first codebook and generating the second message without bandwidth-conserving encoding.

12. The method of claim 3, wherein the method further comprises decoding the first message according to the first codebook and generating the second message without bandwidth-conserving encoding based on a determination that the terminating UE is attached to a base station that is not bandwidth-restricted.

13. The method of claim 11, wherein the base station that is not bandwidth-restricted has a congestion level less than a second predetermined threshold.

14. A non-transitory computer readable media having computer-readable instructions stored thereon that, when executed by one or more computer processing components, cause the one or more computer processing components to perform a method comprising:
receiving a first message from an originating user equipment (UE) via a bandwidth-restricted base station;
determining that the first message is encoded according to a first codebook;
determining that the first message is destined for a terminating UE;
determining the terminating UE is configured to decode incoming messages according to a second codebook; and
communicating a second message to the terminating UE according to the second codebook.

15. A system for bandwidth-restricted messaging comprising:
a transmitter for wirelessly communicating with a base station;
a non-transitory computer readable media;
an alphanumeric input component; and
one or more computer processing components configured to perform a method comprising:
receiving an alphanumeric input via the alphanumeric input component;
determining that the system is attached to the base station and that the base station is bandwidth-restricted;
based on said determination, creating an encoded message by encoding the alphanumeric input according to a codebook stored on the non-transitory computer readable media; and
causing the system to communicate the encoded message to the base station.

16. The system of claim 15, wherein the codebook is downloaded from a wireless communication network as a result of an input instruction from a user.

17. The system of claim 15, wherein the codebook is downloaded from a wireless communication network without a user input based on a determination that the system is approaching a terrestrial coverage boundary.

18. The system of claim 15, wherein the codebook is downloaded via a direct peer to peer connection with a second UE.

19. The system of claim 15, wherein the determination that the base station is bandwidth-restricted is based on a determination that the base station is an extraterrestrial base station.

20. The system of claim 15, wherein the determination that the base station is bandwidth-restricted is based on receiving a congestion indicator from the base station.
